(19) United States
(12) Patent Application Publication
(10) Pub. No.: US 2010/0217499 A1
(43) Pub. Date: Aug. 26, 2010

(54) MECHANICAL POWER GENERATION

(76) Inventor: Fernando Gracia Lopez, Garza Garcia (MX)

Correspondence Address: FISH & RICHARDSON P.C., P.O. BOX 1022, MINNEAPOLIS, MN, 55440-1022, US

(21) Appl. No.: 12/691,573

(22) Filed: Jan. 21, 2010

Related U.S. Application Data
(60) Provisional application No. 61/146,262, filed on Jan. 21, 2009.

(51) Int. Cl. F02B 75/28; F02B 75/18; G06F 19/00

(52) U.S. Cl. 701/102; 123/52.1; 123/51 R

(57) ABSTRACT

Systems, processes, devices, and articles of manufacture for mechanical power generation may be implemented by various techniques. In certain implementations, a mechanical power generator may include a number of cylinders that each have at least two combustion chambers with interconnected pistons. The power generator may also include a fuel controller and an exhaust controller for each combustion chamber. A number of force conversion members may each be associated with respective ones of the cylinders by being coupled to a piston in the associated cylinder at one end. A torque conveying member may be coupled to another end of the force conversion members.

### RELATED APPLICATIONS

This application claims priority under 35 U.S.C. §119(e) to U.S. Provisional Application No. 61/146,262, which was filed on Jan. 21, 2009, and which is herein incorporated by reference in its entirety.

### BACKGROUND

As the world continues to grow in population and industrialization, its power requirements will continue to expand. Some power requirements are fairly constant and, hence, may be met by power generators that deliver a generally constant power. These power generators may be designed to deliver the required power in an efficient manner. However, some power requirements are highly variable. For example, the operation of a vehicle often requires short high-power outputs (e.g., when accelerating), sustained moderate-power outputs (e.g., when cruising), and sustained low-power outputs (e.g., when idling).

### SUMMARY

The following disclosure relates to systems, processes, devices, and articles of manufacture for mechanical power generation. In one general aspect, mechanical power generation may be achieved by a system including a number of cylinders that each include at least two combustion chambers. Each combustion chamber may have a piston, and the pistons for a cylinder may be interconnected. Each combustion chamber may also have an associated fuel controller and exhaust controller. The fuel controllers may, for example, include direct fuel injectors. Respective force conversion members (e.g., connecting rods) may be associated with respective cylinders by being coupled to a piston in the associated cylinder at one end. A torque conveying member (e.g., a crankshaft) may be coupled to another end of the force conversion members.

Certain implementations may include a lubrication inlet for each combustion chamber and a lubrication outlet for each combustion chamber. Additionally, a combustion initiation device may be included for each combustion chamber.

Particular implementations may include a second torque conveying member driven by the cylinders. The second torque conveying member may allow the power generator to produced rotary at two different locations.

The power generator may also include a controller. The controller may determine whether an adjustment to the amount of power produced by the power generator is required and whether to deactivate one or more of the combustion chambers based on the determined power adjustment. The controller may be further operable to determine whether to activate one or more of the combustion chambers based on the determined power adjustment.

In another general aspect, a mechanical power generator includes at least one cylinder that has at least two combustion chambers, a piston in each combustion chamber, and a connecting member coupling the pistons to each other. The power generator may also include a fuel intake for each combustion chamber, and an exhaust outtake for each combustion chamber.

The power generator may also include a lubrication inlet for each combustion chamber and a lubrication outlet for each combustion chamber. The power generator may additionally include a combustion initiation device for each combustion chamber.

In certain implementations, the power generator may include a first torque conveying member driven by the cylinder. The power generator may also include a second torque conveying member driven by the cylinder.

In some implementations, the power generator may include a controller. The controller may be adapted to determine whether an adjustment to the amount of power produced by the power generator is required and whether to deactivate one or more of the combustion chambers based on the determined power adjustment. Additionally, the controller may be adapted to determine whether to activate one or more of the combustion chambers based on the determined power adjustment.

Another general aspect includes a process for controlling a mechanical power generator having a number of cylinders that each include a number of combustion chambers. The process may include determining whether an adjustment to the power being generated by the power generator is required and determining whether one or more additional combustion chambers of the power generator need to be activated based on whether an adjustment to the power being generated is required.

The process may also include determining whether one or more active combustion chambers of the power generator need to be deactivated based on whether an adjustment to the power being generated is required. Additionally, the process may include determining whether to adjust the power generated by active combustion chambers based on whether an adjustment to the power being generated is required.

In another general aspect, an apparatus may control a mechanical power generator having a number of cylinders that each include a number of combustion chambers. The apparatus may, for example, include computer memory storing instructions and a processor operable according to the instructions. The processor may determine whether an adjustment to the power being generated by the power generator is required and determine whether one or more additional combustion chambers of the power generator need to be activated based on whether an adjustment to the power being generated is required.

In certain implementations, the processor may also determine whether one or more active combustion chambers of the power generator need to be deactivated based on whether an adjustment to the power being generated is required. Additionally, the processor may determine whether to adjust the power generated by active combustion chambers based on whether an adjustment to the power being generated is required.

In a particular aspect, a mechanical power generator may include a plurality of cylinders that each have a number of combustion chambers, a piston in each combustion chamber, and a plurality of connecting members coupling the pistons to each other. The power generator may also include a fuel controller, a combustion initiation device and, an exhaust controller for each combustion chamber. The fuel controllers may, for example, include direct fuel injectors. Additionally, the power generator may include a lubrication inlet for each combustion chamber and a lubrication outlet for each combustion chamber. A number of connecting rods may be coupled to a piston in an associated cylinder at one end, and a crankshaft may be coupled to another end of the connecting rods and driven thereby. A controller may be adapted to determine whether an adjustment to the power being generated by the power generator is required and to determine whether one or more additional combustion chambers of the power generator need to be activated based on whether an adjustment to the power being generated is required.

The various techniques for mechanical power generation may have a variety of features. For example, a larger amount of power may be generated while using a smaller stroke and/or combustion chamber. Thus, many of the components of a power generator having multiple-chambered cylinders may be smaller and lighter compared to power generators having single-chambered cylinders that generate equivalent power. In addition, the amount of power is variable through activating/deactivating combustion chambers. When high power is needed, for example, all of the combustion chambers in a cylinder may be used. However, when low power is needed, various combustion chambers may be deactivated, which may save on fuel.

The details of one or more implementations are set forth in the accompanying drawings and the description below. Other features will be apparent from the description and drawings, and from the claims.

### DESCRIPTION OF DRAWINGS

FIG. 1 is a line drawing illustrating an example mechanical power generator.

FIG. 2 is a line drawing illustrating an example cylinder for a mechanical power generator.

FIG. 3 is a line drawing illustrating a sectioned view of an example cylinder for a mechanical power generator

FIG. 4 is a line drawing illustrating a magnified sectioned view of an example cylinder for a mechanical power generator.

FIG. 5 is a block diagram illustrating a control system for a mechanical power generator.

FIG. 6 is a flow diagram illustrating an example process for controlling a mechanical power generator.

FIG. 7 is a line drawing illustrating an example cylinder for an additional example mechanical power generator.

FIG. 8 is a line drawing illustrating a mechanical power generator incorporating the cylinder in FIG. 7.

FIG. 9 is a line drawing illustrating a sectioned view of an example cylinder, fuel introduction system, exhaust extraction system, and combustion initiator for a mechanical power generator.

FIG. 10 is a line drawing illustrating an additional example mechanical power generator.

FIG. 11 is a line drawing illustrating a sectioned view of another example mechanical power generator.

FIG. 12 is a flow diagram illustrating an example process for controlling a mechanical power generator.

Like reference symbols in the various drawings indicate similar elements.

### DETAILED DESCRIPTION

Systems, processes, devices, and articles of manufacture for mechanical power generation may be implemented by a variety of techniques. In certain implementations, for example, a power generator may include one or more multi-chambered cylinders. Each chamber in a cylinder may generate power by combusting fuel (e.g., gasoline, diesel, or compressed natural gas) and be individually controlled (e.g., by adjusting the introduction of fuel) to adjust the amount of power produced by the power generator. In certain situations, for example, one or more chambers, or even an entire cylinder, may be activated or deactivated as necessary. Other implementations are also described below.

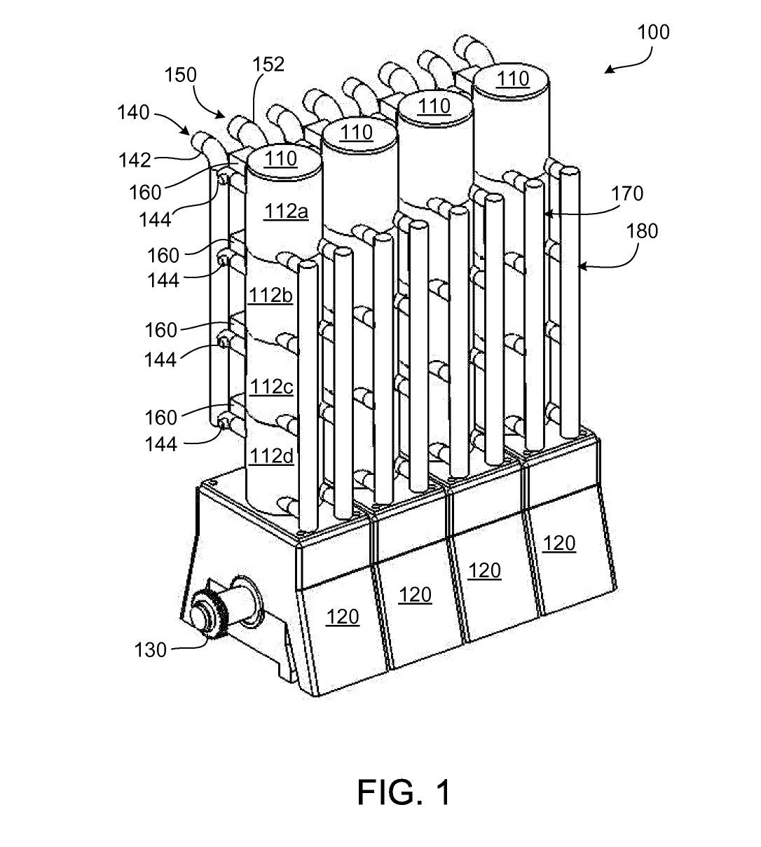

FIG. 1 illustrates one example of a mechanical power generator 100. Power generator 100 includes a number of cylinders 110 in which mechanical power is generated by the combustion of fuel (e.g., gasoline). Each cylinder 110 includes four combustion chambers 112a-d. The combustion in each of chambers 112 may be independently controlled so that the power generated by each cylinder may be varied in accordance with load, speed, and/or other power requirements. Cylinders 110 may be made of metal, ceramic, and/or any other appropriate material and may have a circular, elliptical, or other appropriate cross-section. Cylinders 110 may be oriented in a vertical, horizontal, inclined, or other appropriate orientation.

Each of cylinders 110 is coupled to one of bases 120, which stabilize the cylinders and support a torque conveying member 130 (e.g., a crankshaft). Bases 120 may, for example, be blocks. The mechanical power generated by the cylinders 110 is converted into torque to drive member 130. Bases 120 may be made of metal, ceramic, and/or any other appropriate material.

Coupled to each cylinder 110 is a fuel introduction system 140 and an exhaust extraction system 150. Fuel introduction system 140 includes a manifold 142 (e.g., a fuel rail) through which fuel may be brought to the combustion chambers 112. Fuel introduction system 140 also includes fuel controllers 144, which are responsible for introducing the fuel into the combustion chambers 112. Fuel controllers 144 may be independently controlled. Thus, the ability to generate power in each combustion chamber 112 may be independently controlled.

Fuel controllers 144 may, for example, include valves, fuel injectors, and/or any other appropriate components. Fuel injectors may be electronically controlled and operate so that they are normally closed, but open to introduce fuel, which may be pressurized, as long as electricity is applied to the injector. The duration of the fuel introduction (known as pulse width) is typically proportional to the amount of fuel desired. The electric pulse for fuel injectors may be applied in a sequential or batch fire system. Fuel injectors may work in conjunction with intake valves or may directly insert fuel into the combustion chambers (e.g., direct fuel injectors). Particular implementations may include multiple valves per combustion chamber.

Exhaust extraction system 150 includes a manifold 152 to collect the exhaust (e.g., combusted gases) from the combustion chambers 112. The exhaust extraction system 150 may also include one or more exhaust controllers for each combustion chamber 112 to control airflow into and out of the chambers. The exhaust from the manifold 152 may be released to the atmosphere, possibly after being conditioned by other components (e.g., a catalytic converter).

Power generator 100 also includes a combustion initiator 160 for each combustion chamber 112. The combustion initiators 160 may, for example, include devices that generate an electrical signal (e.g., spark plugs) to ignite a fuel/air combination. The combustion initiators 160 may be independently controlled. Thus, the ability to generate power in each combustion chamber 112 may be further independently controlled.

Power generator 100 also includes a lubrication introduction system 170 and a lubrication extraction system 180 for each cylinder 110. Each lubrication introduction system 170 delivers lubricant (e.g., oil) from the associated base 120 to each combustion chamber 112 in a cylinder 110. Lubrication introduction systems 170 may, for example, include pumps for circulating the lubricant. In certain implementations, the lubricant may be delivered to the walls of the combustion chambers. Lubrication extraction systems 180 collect the lubricant from the combustion chambers 112 and return it to the bases 120, from which it may be returned to the combustion chambers through lubrication introduction system 170. Lubrication extraction system 180 may also allow gas (e.g., air) to enter and evacuate behind the piston heads of the combustion chambers as they move, which may avoid losses due to compression and/or vacuum.

Combustion chambers 112 may operate through a four stroke technique—1) fuel/air introduction; 2) compression; 2) combustion; and 4) exhaust. Power generator 100 may generate varying amounts of power by varying the amount of fuel provided to each combustion chamber 112 and/or varying the number of combustion chambers 112 that are active. For example, when high power is needed, all of the combustion chambers in each cylinder 110 may be used. When a moderate amount of power is needed, however, a number of combustion chambers may be deactivated. For example, one or two combustion chambers may cease to be provided with fuel and/or combustion initiation. (Operation of the exhaust extraction system 150 for the deactivated combustion chambers may continue, however, to avoid resistance situations for the pistons in the deactivated combustion chambers (e.g., vacuum or compression).) And when a low amount of power is needed all but one combustion chamber 112 in a cylinder 110 may be deactivated. The combustion modes (e.g., stoichiometric, full power, lean, etc.) in each combustion chamber may also be varied to adjust power.

In some implementations, there may be an order in which combustion chambers 112 are deactivated/activated. For example, some implementations may call for deactivating combustion chambers 112 in a cylinder 110 beginning with the one furthest from the base 120. This may enhance stability for the power generator. Additionally, a similar number of combustion chambers 112 in cylinders 110 may be deactivated at the same time. This may assist in keeping balance in the power generator. In particular implementations, similarly-situated combustion chambers 112 in cylinders 110 may be deactivated at the same time. The activation sequence may be the reverse of the deactivation sequence.

In certain implementations, all of the combustion chambers 112 in one or more cylinders 110 may be deactivated. For example, in a power generator with a number of cylinders, a single cylinder may be deactivated. However, in particular implementations, two or more cylinders may need to be deactivated to maintain stability and balance.

The selection of the active and inactive combustion chambers 112, as well as the combustion modes for the chambers, may be made by a power generator controller, which will be discussed in more detail below. In general, the controller may be a logical device having a set of instructions that determines when and which combustion chambers 112 to activate/deactivate and how they will operate.

Cooling of power generator 100 may be accomplished by any appropriate techniques. For example, a cooling liquid could be pumped through the walls of the cylinders 110. In certain implementations, power generator 100 could, at least in part, be cooled through air flow.

Power generator 100 has a number of features. For example, a larger amount of power may be generated while using a smaller stroke and/or combustion chamber. Thus, many of the components of power generator 100 may be smaller and lighter compared to single-chambered cylinders of power generators that generate equivalent power. In addition, the amount of power is variable through activating/deactivating combustion chambers. When high power is needed, for example, all of the combustion chambers in each cylinder may be used. However, when low power is needed, various combustion chambers may be deactivated, which may save on fuel.

Power generator 100 may have a variety of uses. For example, it may be used to provide motive power for a vehicle (e.g., car or truck). Additionally, power generator 100 may be able to work with and/or without a variable gearing system (e.g., a transmission) to supply power to a driven device (e.g., vehicle wheels).

Power generator 100 may include additional, fewer, and/or a different arrangement of components in other implementations. For example, in some implementations, power generator 100 may not include combustion initiators 160. This may occur, for instance, if the power generator operates using diesel as fuel. As another example, a cylinder 110 may include fewer or additional combustion chambers. As a further example, power generator 100 may include fewer or additional cylinders. As an additional example, power generator 100 does not have to drive a torque conveying member 130. In general, power generator 100 may be configured to drive any number of power transmission elements.

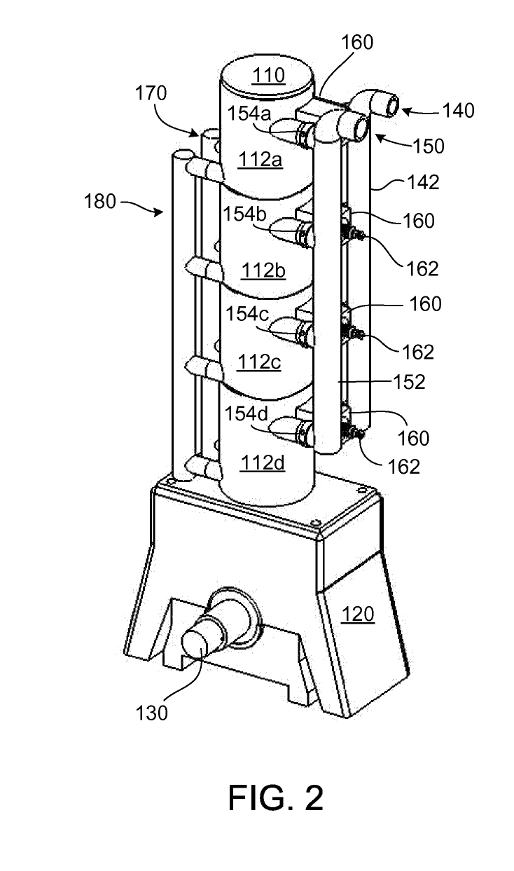

FIG. 2 illustrates an example cylinder 110 from another perspective. In this view, exhaust extraction system 150 includes a number of exhaust controllers 154a-d (one for each combustion chamber 112a-d). In particular implementations, exhaust controllers 154 may be valves. Exhaust controllers 154 may be controlled to provide for exhaust of the combustion gases during the exhaust stroke of combustion chambers 112. Exhaust controllers 154 may also be independently controlled to prevent resistance (e.g., vacuum and/or compression) when a combustion chamber 112 is inactive. In some implementations, one of exhaust controllers 154 may serve one or more of the combustion chambers 112. Also in this view, combustion initiators 160 include spark plugs 162.

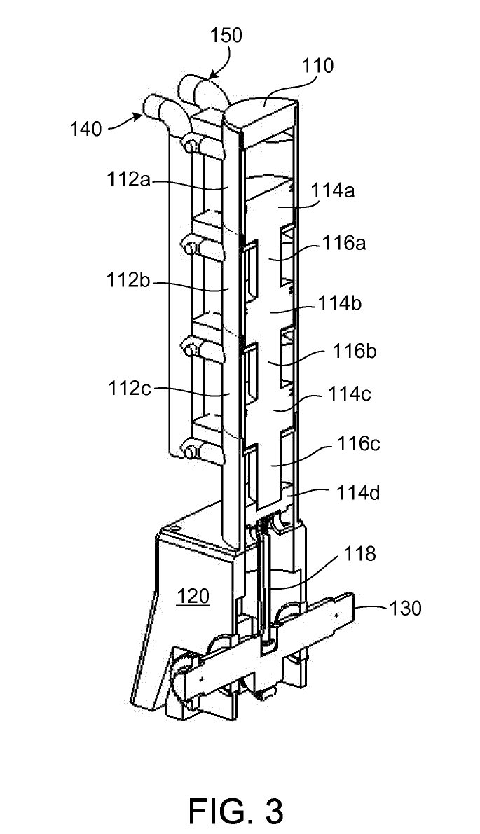

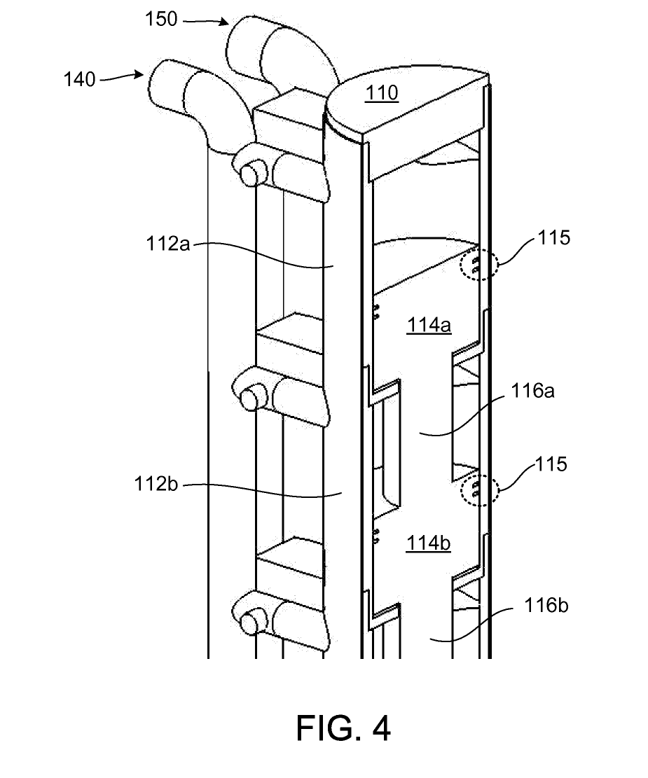

FIG. 3 illustrates a cross-section of an example cylinder 110, and FIG. 4 illustrates a magnified view of a portion of the cylinder. As can be seen, each combustion chamber 112 includes a piston 114a-d, which may be made of any appropriate material (e.g., metal). Pistons 114 are coupled to each other through connecting members 116. Pistons 114 and connecting members 116 may be formed as a unitary whole (e.g., by casting) or may be formed of disparate parts As the power generator operates, portions of connecting members 116 alternate being ahead of and behind pistons 114, and, thus, are made of appropriate materials (e.g., metal). For example, as illustrated, pistons 114 are at the bottom of combustion chambers 112, and connecting member 116a is ahead of piston 114b, connecting member 116b is ahead of piston 114c, and connecting member 116c is ahead of piston 116d. Thus, connecting members 116 may have just been subjected to a combustion stroke or an intake stroke. When the pistons return to the top of combustion chambers 112 (e.g., after a compression stroke), connecting member 116a will be behind piston 114a, connecting member 116b will be behind piston 114b, and connecting member 116c will be behind piston 116c. Thus, portions of connecting members 116 will transition between combustion chambers 112. The dividers between the combustion chambers 112 may have appropriate seals and rings to prevent pass-through of combustion gases and/or lubricant.

Cylinder 110 also includes a force conversion member 118 for transferring the force from the movement of pistons 114 to torque conveying member 130. As illustrated, force conversion member 118 may accomplish this by being pivotally coupled at one end to piston 114d and at the other end to torque conveying member 130. As pistons 114 move in a reciprocating linear fashion, force conversion member 118 rotates torque conveying member 130. In particular implementations, force conveying member 118 is a connecting rod.

As can best be seen in FIG. 4, pistons 114 include rings 115. Rings 115 provide a sliding seal between the outer edge of the pistons and the inner walls of the cylinder. The rings may serve two purposes: 1) they may prevent the fuel/air mixture and exhaust in the combustion chamber from leaking behind the piston during compression and combustion; and 2) they may keep lubricant behind the piston from leaking into the combustion area, where it would be burned. Rings 115 may, for example, be open-ended metal rings that fit into a groove on the outer diameter of a piston.

A piston 114 may have any number of rings. For example, some implementations may include two rings that are used primarily for compression sealing and another ring for controlling the supply of lubricant to a liner that lubricates the piston skirt and the compression rings.

Although the mechanical power generators have been shown as generating rotary power, other implementations may generate other forms of mechanical power. For example, in certain implantations, a mechanical power generator could generate linear power.

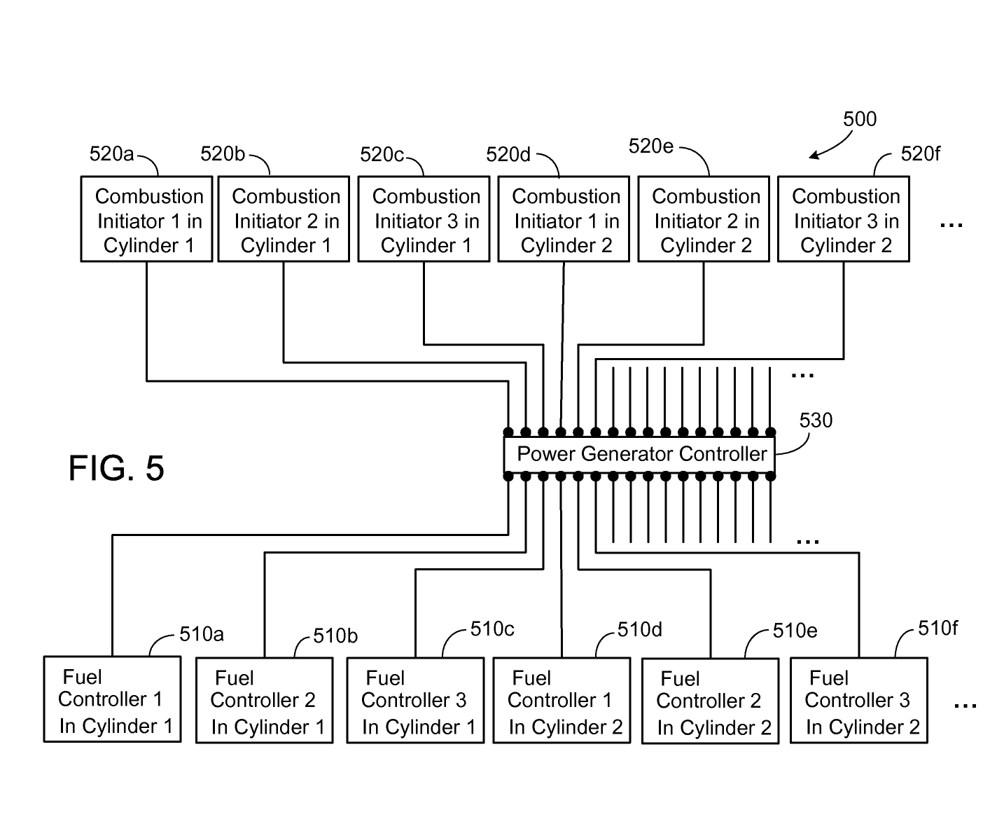

FIG. 5 illustrates a control system 500 for a power generator such as power generator 100. Control system 500 includes fuel controllers 510, combustion initiators 520, and a power generator controller 530.

Each fuel controller 510 is responsible for delivering fuel to a particular combustion chamber. For example, fuel controller 510a is responsible for delivering fuel to a first combustion chamber in a first cylinder, and fuel controller 510b is responsible for delivering fuel to a second combustion chamber in the cylinder. Fuel controllers 510 may, for example, include fuel injectors.

Each combustion initiator 520 is responsible for initiating combustion in a particular combustion chamber. For example, combustion initiator 520a is responsible for initiating combustion in the first combustion chamber of the first cylinder, and combustion initiator 520b is responsible for initiating combustion in the second combustion chamber of the first cylinder. Combustion initiators 520 may, for example, include spark plugs.

Power generator controller 530 is coupled to fuel controllers 510 and combustion initiators 520. Controller 530 monitors operating parameters via various sensors to determine the proper amount of fuel to deliver to each combustion chamber, the proper ignition timing, and/or which combustion chambers to activate/deactivate. For example, controller 530 may monitor a mass airflow sensor, an oxygen sensor, a throttle position sensor, a coolant temperature sensor, a voltage sensor, a manifold pressure sensor, and a power generator operating speed sensor. The controller interprets these parameters in order to calculate which combustion chambers should be active and how much fuel to introduce to each combustion chamber, among other tasks, and controls power generator operation by manipulating fuel and/or air flow as well as other variables. The optimum amount of active combustion chambers and/or introduced fuel depends on conditions such as power generator and ambient temperatures, power generator operating speed and workload, and exhaust gas composition. If, for example, fuel controllers 510 are fuel injectors, controller 530 may determine a pulse width for the fuel injectors.

Power generator controller 530 can work with multi-port or sequential-port fuel injector systems. In multi-port injector systems, the fuel injectors can all open at the same time. In sequential port injector systems, each fuel injector can open just before it is needed (e.g., just before the intake valve for its combustion chamber opens). Although a little more complicated, an advantage of sequential-port fuel injection is that if a sudden change in required power occurs, the system can respond more quickly because it only has to wait until the next introduction event, instead of a complete revolution.

Because fuel injectors dispense fuel in discrete amounts, and the four-stroke cycle has discrete fuel-introduction events, the power generator controller 530 can determine fuel in discrete amounts. In a multi-port system, the fuel amount can be determined in every revolution. In a sequential system, the fuel amount may be tailored for each individual introduction event. In some implementations, every introduction event for every combustion chamber for every cylinder of the entire power generator may use a separate fuel mass calculation, and each injector may receive a unique pulse width based on that combustion chamber's fuel requirements. Moreover, in a direct introduction system, precise control over the amount of fuel and introduction timings, which vary according to the load conditions, may be achieved. Direct injection may also be accompanied by other technologies such as variable valve timing, tuned/multi path, or variable length intake manifolding.

Power generator controller 530 may also select between different combustion modes—lean, stoichiometric, and full power output, for example. Each mode is characterized by the air-fuel ratio. For stoichiometric burn, fuel is injected during the intake stroke, creating a homogeneous fuel-air mixture in the combustion chamber. From the stoichiometric ratio, an optimum burn results. The stoichiometric air-fuel ratio for gasoline is about 14:1 by weight. Lean mode may involve much higher ratios. These leaner mixtures, which can be used in light-load conditions, can reduce fuel consumption. For these mixtures, the fuel may be injected at the latter stages of the compression stroke rather than during the intake stroke, to place the air-fuel mixture optimally near combustion initiators 520. Full power mode may be used for rapid acceleration and heavy loads (e.g., when climbing a hill). For full power mode, the air-fuel ratio may be slightly higher than stoichiometric. The fuel may be injected during the intake stroke.

Controller 530 may also control the timing of combustion initiators 520. The timing of combustion initiators 520 may need to be varied base on a variety of parameters, such as power generator operating speed and air mixture. For example, the fuel may burn faster or slower depending on the type of air that is incoming. Thus, the timing of the initiation may need to be advanced or retarded. Additionally, because the speed of the pistons increases the faster the power generator operates, the fuel/air mixture has less time to reach its maximum pressure during combustion. Thus, initiation may occur earlier the faster the power generator operates. Other goals, like minimizing emissions, may be important too, especially when maximum power is not required. For instance, by retarding the initiation timing in gasoline-based power generators (i.e., moving the initiation closer to the top of the compression stroke), maximum combustion chamber and temperatures can be reduced, which can lower the formation of nitrogen oxides (NOx)—a regulated pollutant.

Controller 530 may be any logically-driven device. For example, controller 530 may include a processor (e.g., a microprocessor) that operates according to a set of logical instructions (e.g. firmware and/or software). The instructions may be stored in random-access memory (e.g., RAM), read-only memory (e.g., ROM or PROM), semi-permanent memory (e.g., EEPROM), and/or any other type of information storage device. The memory may have the ability to be updated with new instructions and/or operational data.

Controller 530 may receive input regarding the power generator in a variety of ways. For example, the controller may be coupled to sensors that indicate the power output of the power generator. Thus, the controller may receive data regarding whether the power generator is responding to its commands and respond accordingly. Additionally, the controller may be coupled to a sensor that detects the amount of power requested (e.g., from a throttle). Thus, the controller may be controlled by an input command for the power generator. Additionally, the controller may be coupled (e.g., over a bus or network) to another logical device that determines how much power the power generator should be producing (e.g., a regulator). The controller 530 may include one or more communication interfaces for receiving various input signals.

Although controller 530 is illustrated as being directly wired to fuel controllers 510 and combustion initiators 520, it should be understood that there may be a number of intervening components (e.g., amplifiers, AID converters, D/A converters, ignition coils, and distributors). In some implementations, for example, controller 530 controls an ignition coil that is coupled to a spark plug. The ignition coil can be part of or separate from a combustion initiator 520.

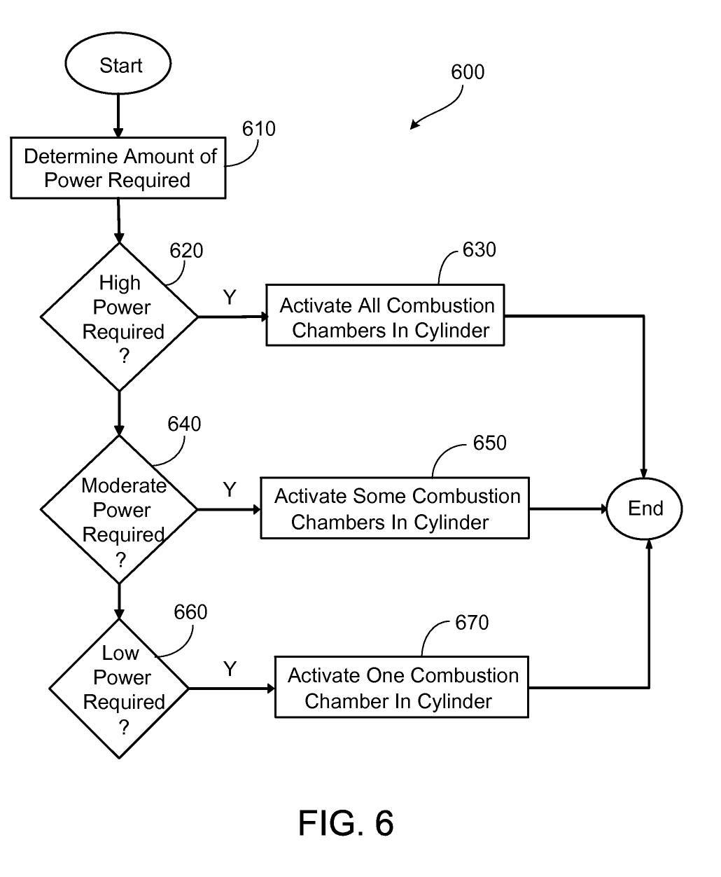

FIG. 6 illustrates an example process 600 for controlling a power generator. Process 600 may, for example, be one of a number of processes that can be executed by a power generator controller.

Process 600 begins with determining the amount of power required from the power generator (operation 610). The amount of power required may, for example, be based on the current operating speed and load of the power generator and/or whether a change in power has been requested. Changes in requested power requested may come from a manual command (e.g., from a throttle) or from an automated command (e.g., from a control module).

Process 600 continues with determining whether a high power is required (operation 620). If a high power is required, process 600 continues with activating all of the combustion chambers in a cylinder (operation 630). Activating the combustion chambers may encompass activating previously inactive combustion chambers and/or continuing to use previously active combustion chambers. Process 600 is then at an end.

If a high power is not required, process 600 determines whether a moderate power is required (operation 640). If a moderate power is required, process 600 activates some of the combustion chambers in a cylinder (operation 650). Activating the combustion chambers may encompass activating previously inactive combustion chambers, deactivating previously active combustion chambers, and/or continuing to use previously active combustion chambers. Process 600 is then at an end.

If a moderate power is not required, process 600 determines whether a low power is required (operation 660). If a low power is required, process 600 activates one of the combustion chambers in a cylinder (operation 660). Activating the combustion chamber may encompass deactivating previously active combustion chambers and/or continuing to use a previously active combustion chamber. Process 600 is then at an end.

Although process 600 has been discussed for one cylinder, it should be understood that the process may be repeated for multiple cylinders or the results from the process can be applied to multiple cylinders. Additionally, it should be understood that process 600 may be performed repeatedly (e.g., several times a second). The process may be triggered based on any of a variety of factors, such as, for example, time or performance changes (e.g., increased throttle or load).

Although FIG. 6 illustrates one example of a process for controlling a power generator, other processes may have fewer, additional, and/or a different arrangement of operations. For example, a process may not have to determine what level of power is required (e.g., high versus low). A process may, for instance, determine the required power and use this to determine (e.g., through equation or table look up) the number of combustion chambers to activate. As another example, a process may determine the identity of the combustion chambers to activate. Also, a process may determine whether an adjustment in the amount of fuel delivered (e.g., through a change pulse width), the time of combustion initiation (e.g., through initiation retardation), and/or the timing of fuel introduction to the active combustion chambers may satisfy the power requirement. This may, for example, be beneficial for small, temporary changes in required power.

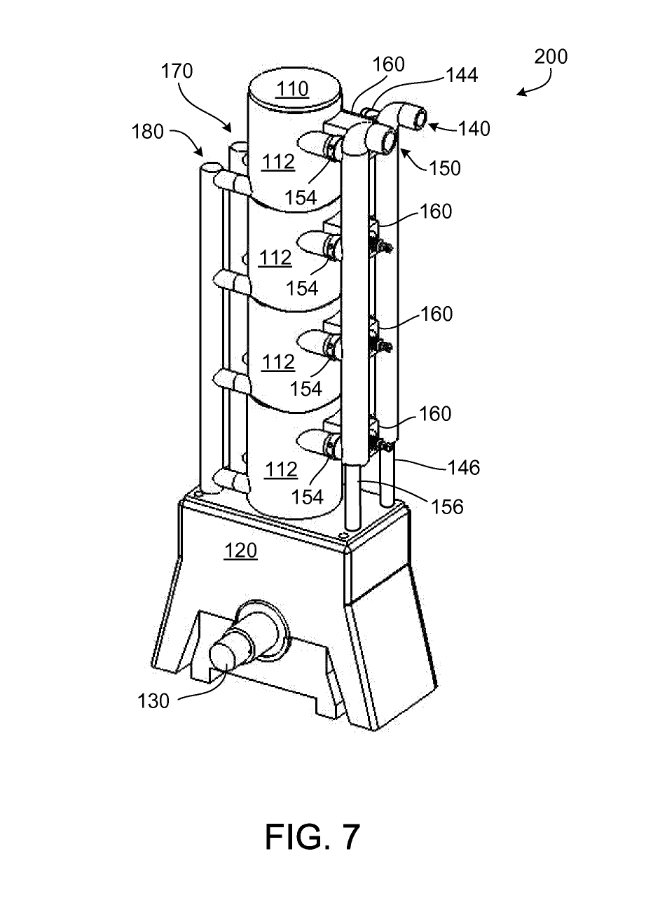

FIG. 7 illustrates another example mechanical power generator 200. Similar to power generator 100, power generator 200 includes a cylinder 110 that has a number of combustion chambers 112. Power generator 200 also includes a base 120, a torque conveying member 130, a fuel introduction system 140, an exhaust extraction system 150, a combustion initiator 160 for each combustion chamber 112, a lubrication introduction system 170, and a lubrication extraction system 180.

Fuel introduction system 140 includes a fuel controller 144 for each combustion chamber 112 and a cam shaft 146. In this implementation, each of fuel controllers 144 includes a valve for controlling the introduction of fuel into a combustion chamber 112. Cam shaft 146 is used to open and close the valves of fuel controllers 144.

Cam shaft 146 may be driven by torque conveying element 130 (e.g., through the use of a timing belt).

Similar to fuel introduction system 140, exhaust extraction system 150 includes an exhaust controller 154 for each combustion chamber and a cam shaft 156. Each of exhaust controllers 154 includes a valve for controlling the exit of combusted gases from a combustion chamber 112. Cam shaft 156 is used to open and close the valves of exhaust controllers 154. Cam shaft 156 may be driven by torque conveying element 130 (e.g., through the use of a timing belt).

Although FIG. 7 only illustrates one cylinder for power generator 200, it should be understood that such a power generator could have additional cylinders. Moreover, each cylinder could assist in driving torque conveying member 130.

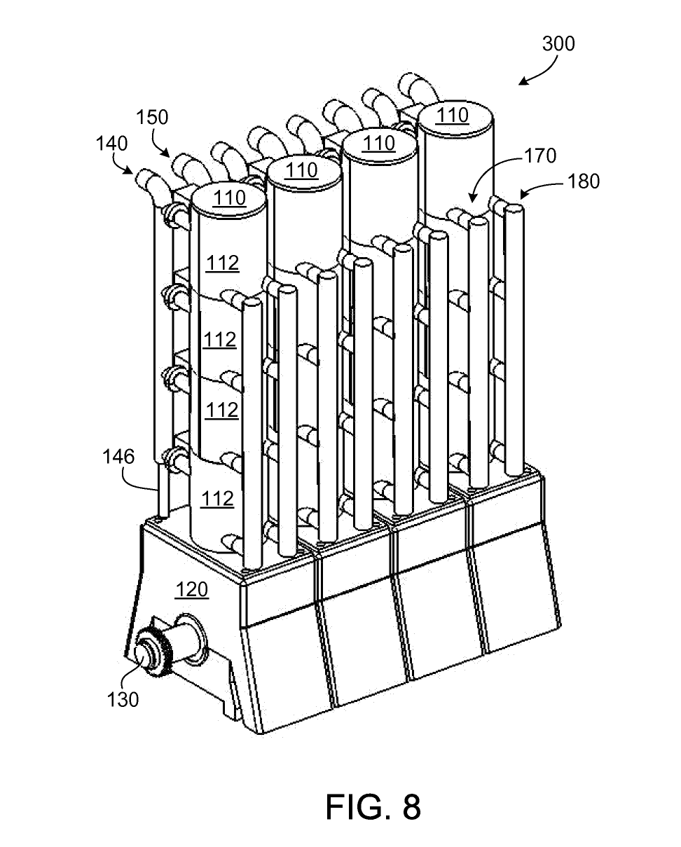

FIG. 8 illustrates an example power generator 300 incorporating a power generator similar to power generator 200. Power generator 300 has a number of cylinders 110 that each include a number of combustion chambers 112. Each cylinder 110 is coupled to a base 120. Bases 120 support torque conveying member 130, and cylinders 110 drive torque conveying member 130. The torque conveying member, in turn, drives cam shafts 146 and 156 of fuel introduction system 140 and exhaust extraction system 150, respectively, to operate valves therein.

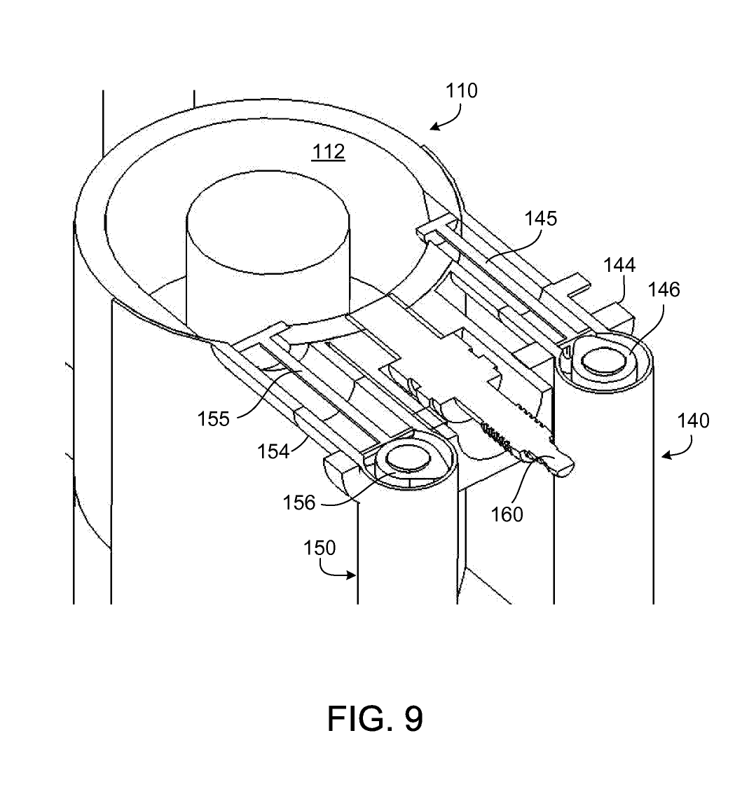

FIG. 9 illustrates a sectioned view of a cylinder 110, a fuel introduction system 140, an exhaust extraction system 150, and a combustion initiator 160 for a mechanical power generator, such as, for example, power generator 200. Fuel introduction system 140 includes a fuel controller 144 for a combustion chamber 112 and a cam shaft 146. Fuel controller 144 includes a valve 145 that controls the introduction of fuel from fuel controller 144 into combustion chamber 112. Cam shaft 146 is used to open and close valve 145 of fuel controller 144.

For example, valve 145 may be made so that it is predisposed to being closed (e.g., through the use of a spring). As cam shaft 146 rotates, however, the lobes of the cam shaft may force the valve 145 toward the combustion chamber 112, opening the valve and allowing fuel from the fuel controller 144, which may, for example, also include an electronically controlled fuel injector, to enter the combustion chamber 112. The operation of the cam shaft 146 may be sequenced to open the valve at any appropriate point of the operating cycle of combustion chamber 112, although the valve is typically opened during an intake stroke of a piston. Cam shaft 146 may also control the operation of fuel introduction valves for a number of other combustion chambers.

Exhaust extraction system 150 includes an exhaust controller 154 for the combustion chamber 112 and a cam shaft 156. Exhaust controller 154 includes a valve 155 for controlling the exit of combusted gases from combustion chamber 112. Cam shaft 156 is used to open and close valve 155 of exhaust controller 154.

For example, valve 155 may be made so that it is predisposed to being closed (e.g., through the use of a spring). As cam shaft 156 rotates, however, the lobes of the cam shaft may force valve 155 toward combustion chamber 112, opening the valve and allowing exhaust to exit the combustion chamber 112. The operation of cam shaft 156 may be sequenced to open the valve at any appropriate point of the operating cycle of the combustion chamber 112, although the valve is typically opened during an exhaust stroke. Cam shaft 156 may also control the operation of exhaust valves for a number of other combustion chambers.

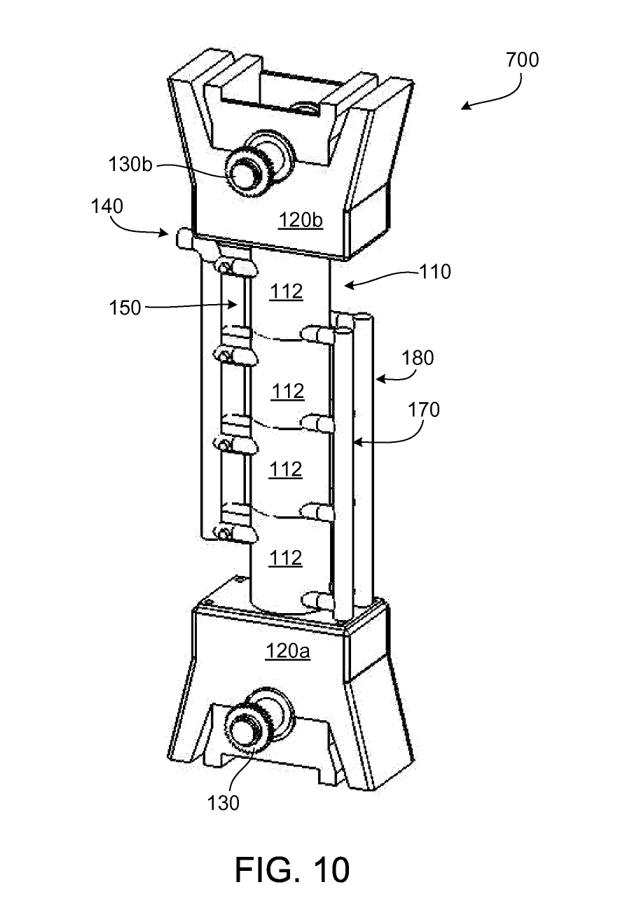

FIG. 10 illustrates another example mechanical power generator 700. Similar to power generator 100, power generator 700 includes a cylinder 110 that has a number of combustion chambers 112. Power generator 700 also includes a fuel introduction system 140, an exhaust extraction system 150, a lubrication introduction system 170, and a lubrication extraction system 180.

Attached to each end of cylinder 110 are bases 120, which stabilize the cylinders and support a respective torque conveying member 130. The mechanical power generated by cylinder 110 is converted into torque to drive members 130. Torque conveying members 130 may, for example, be coupled to the pistons in combustion chambers 112 by connecting rods. Thus, power generator 700 may simultaneously drive two torque conveying outputs.

It should be understood that a mechanical power generator like mechanical power generator 700 may be composed of a number of cylinders 110. Thus, torque conveying members 130 may be driven by a number of cylinders 110.

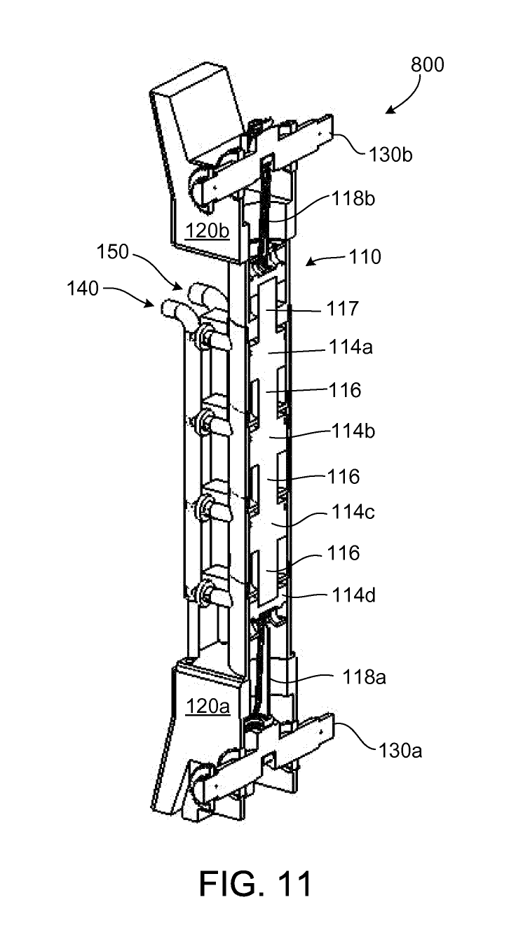

FIG. 11 illustrates another example mechanical power generator 800. Similar to power generator 700, power generator 800 includes a cylinder 110 that has a number of combustion chambers 112. Power generator 800 also includes a fuel introduction system 140 and an exhaust extraction system 150. A lubrication introduction system 170 and a lubrication extraction system 180 may also be included, but are not shown in this sectioned view.

Each of combustion chambers 112 includes a piston 114, which are coupled to each other through connecting members 116. Piston 114a is also coupled to an extension member 117 that protrudes through the cover of the combustion chamber and is driven by pistons 114. Extension member 117 and/or the cover may include appropriate rings and/or seals to prevent leakage from or into the combustion chamber. (A similar arrangement could be used for power generator 700.)

Attached to each end of cylinder 110 are bases 120, which stabilize the cylinder and support a respective torque conveying member 130. Torque conveying member 130a is coupled to pistons 114 by force conversion member 118a, and torque conveying member 130b is coupled to the pistons by force conversion member 118b, which is coupled to extension member 117. The mechanical power generated by cylinder 110 is converted into torque to drive members 130. Thus, power generator 800 may simultaneously drive two torque conveying outputs.

It should be understood that a mechanical power generator like mechanical power generator 800 may be composed of a number of cylinders 110. Thus, torque conveying members 130 may be driven by a number cylinders 112. Additionally, more than two torque conveying members 130 may be coupled to and driven by a motor.

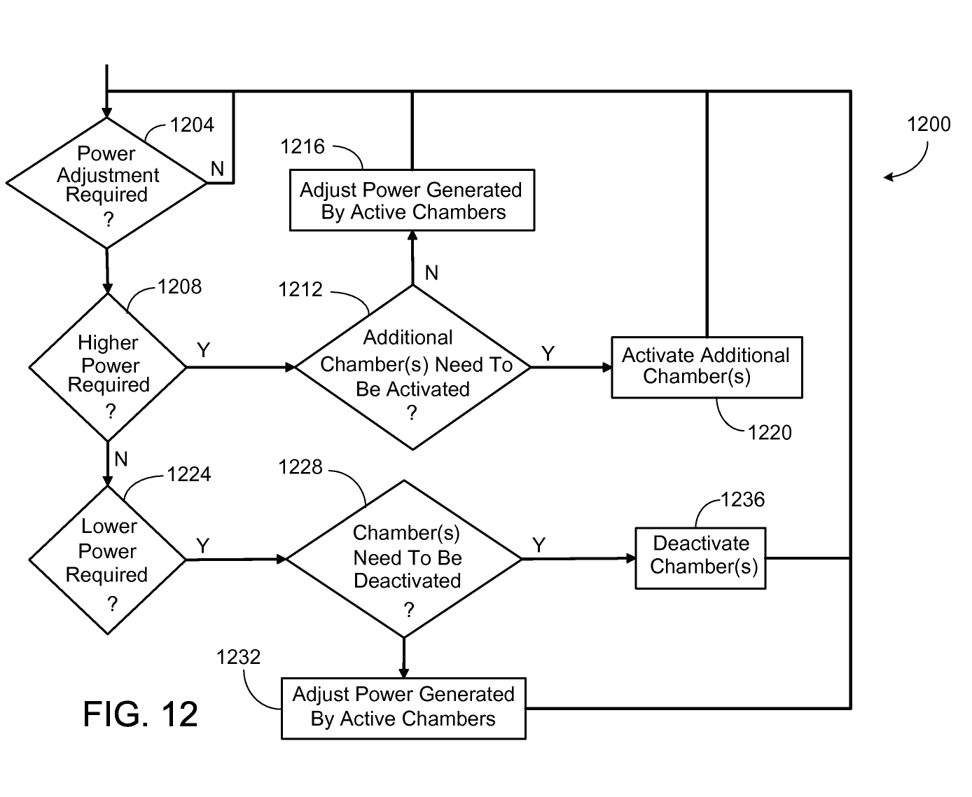

FIG. 12 illustrates an example process 1200 for controlling a mechanical power generator. Process 1200 may, for example, be one of a number of processes that can be executed by a power generator controller.

Process 1200 begins with determining whether an adjustment to the power generated by a power generator is required (operation 1204). An adjustment to the required power may, for example, be based on a change of the current operating speed and/or load of the power generator and/or whether a change in power has been requested. A change in requested power may come from a manual command (e.g., from a throttle) or from an automated command (e.g., from a control module).

If a power adjustment is required, process 1200 continues with determining whether a higher power is required (operation 1208). If a higher power is required, process 1200 calls for determining whether one or more additional combustion chambers need to be activated (operation 1212). Additional combustion chambers may, for example, need to be activated if the active combustion chambers cannot produce enough power.

If no additional combustion chambers need to be activated, process 1200 calls for adjusting the power generated by the active combustion chambers (operation 1216). The power generated by the active combustion chambers may, for example, be adjusted by increasing the amount of fuel supplied to the combustion chambers (e.g., to move from stoichiometric combustion to full power combustion). Process 1200 then calls for determining if another power adjustment is required (operation 1204).

If one or more combustion chambers need to be activated, process 1200 calls for activating the additional chamber(s) (operation 1220). Activating the additional combustion chamber(s) may, for example, include generating commands to supply fuel to the combustion chamber(s). The additional combustion chamber(s) may or may not be part of the same cylinder as the active combustion chamber(s). Process 1200 then calls for determining if another power adjustment is required (operation 1204).

If a higher power is not required, process 1200 determines whether a lower power is required (operation 1224). If a lower is required, process 1200 calls for determining whether one or more active combustion chambers need to be deactivated (operation 1228). Combustion chambers may, for example, need to be deactivated if the active combustion chambers are producing too much power or cannot produce the required power efficiently.

If one or more combustion chambers does not need to be deactivated, process 1200 calls for adjusting the power generated by the active combustion chambers (operation 1232). The power generated by the active combustion chambers may, for example, be adjusted by decreasing the amount of fuel supplied to the combustion chambers (e.g., to move from stoichiometric combustion to lean combustion). Process 1200 then calls for determining if another power adjustment is required (operation 1204).

If one or more combustion chambers need to be deactivated, process 1200 calls for deactivating the additional chamber(s) (operation 1236). Deactivating the combustion chamber(s) may, for example, include ceasing to supply commands to introduce fuel to the combustion chamber(s). The deactivated combustion chamber(s) may or may not be part of the same cylinder as the active combustion chamber(s). Process 1200 then calls for determining if another power adjustment is required (operation 1204).

It should be understood that process 1200 may be performed repeatedly (e.g., several times a second). Additionally, the process may be triggered based on any of a variety of factors, such as, for example, time or performance changes (e.g., increased throttle or load).

Although FIG. 12 illustrates one example of a process for controlling a power generator, other processes may have fewer, additional, and/or a different arrangement of operations. For example, a process may determine what level of power is required. A process may, for instance, determine the required power and use this to determine (e.g., through equation or table look up) the number of combustion chambers to activate or deactivate. Thus, there may be no need to determine whether a higher power or a lower power is required. As another example, a process may determine the identity of the combustion chambers to activate or deactivate. As a further example, a process may determine whether an adjustment to the power generated by the active combustion chamber is sufficient.

As another example, adjustments to the active number of chambers and/or the power generated by the active chambers even if no power adjustment is required. For instance, if the power generator is running in a relatively steady state, it may be determined that another configuration (e.g., fewer active combustion chambers but with increased power production from each) may be more efficient, and a change in operational configuration may be performed.

Additionally, various operations may be performed in a contemporaneous or simultaneous manner. For example, a process may call for determining whether to activate additional combustion chambers and whether to adjust power generated by active chambers, and these operations may be performed in a sequential or simultaneous manner. A process may also call for determining whether to deactivate active combustion chambers and whether to adjust power generated by the active chambers, and these operations may be performed in a sequential or simultaneous manner.

A number of implementations have been described in detail, and several others have been mentioned or suggested. Moreover, those skilled in the art will readily appreciate that numerous additions, deletions, substitutions, and modifications may be made to the implementations while still achieving mechanical power generation. Accordingly, the scope of the protected subject matter should judged based on the following claims, which may encompass one or more aspects of one or more implementations.

1. A mechanical power generator, the generator comprising:
a plurality of cylinders, each cylinder comprising:
at least two combustion chambers,
a piston in each combustion chamber, and
a connecting member coupling the pistons to each other;
a fuel controller for each combustion chamber;
an exhaust controller for each combustion chamber;
a plurality of force conversion members, each member being coupled to a piston in an associated cylinder at one end and driven the pistons in the associated cylinder; and
a torque conveying member coupled to another end of the force conversion members.

2. The power generator of claim 1, further comprising:
a lubrication inlet for each combustion chamber; and
a lubrication outlet for each combustion chamber.

3. The power generator of claim 1, wherein the force conversion members are connecting rods.

4. The power generator of claim 1, wherein the torque conveying member is a crankshaft.

5. The power generator of claim 1, wherein each cylinder includes four combustion chambers.

6. The power generator of claim 1, wherein each fuel controller comprises a direct fuel injector.

7. The power generator of claim 1, further comprising a combustion initiation device for each combustion chamber.

8. The power generator of claim 1, further comprising a second torque conveying member driven by the cylinders.

9. The power generator of claim 1, further comprising a controller for the power generator, the controller adapted to determine whether an adjustment to the amount of power produced by the power generator is required and whether to deactivate one or more of the combustion chambers based on the determined power adjustment.

10. The power generator of claim 9, wherein the controller is further operable to determine whether to activate one or more of the combustion chambers based on the determined power adjustment.

11. A mechanical power generator, the generator comprising:
at least one cylinder, the cylinder comprising:
at least two combustion chambers,
a piston in each combustion chamber, and
a connecting member coupling the pistons to each other;
a fuel intake for each combustion chamber; and
an exhaust outtake for each combustion chamber.

12. The power generator of claim 11, further comprising:
a lubrication inlet for each combustion chamber; and
a lubrication outlet for each combustion chamber.

13. The power generator of claim 11, further comprising a combustion initiation device for each combustion chamber.

14. The power generator of claim 11, further comprising a first torque conveying member driven by the cylinder.

15. The power generator of claim 14, further comprising a second torque conveying member driven by the cylinder.

16. The power generator of claim 11, further comprising a controller for the power generator, the controller adapted to determine whether an adjustment to the amount of power produced by the power generator is required and whether to deactivate one or more of the combustion chambers based on the determined power adjustment.

17. The power generator of claim 16, wherein the controller if further operable to determine whether to activate one or more of the combustion chambers based on the determined power adjustment.

18. A computer-implemented method for controlling a mechanical power generator comprising a number of cylinders that each include a number of combustion chambers, the method comprising:
determining whether an adjustment to the power being generated by the power generator is required; and
determining, using one or more processors, whether one or more additional combustion chambers of the power generator need to be activated based on whether an adjustment to the power being generated is required.

19. The method of claim 18, further comprising determining whether one or more active combustion chambers of the power generator need to be deactivated based on whether an adjustment to the power being generated is required.

20. The method of claim 18, further comprising determining whether to adjust the power generated by active combustion chambers based on whether an adjustment to the power being generated is required.

21. An apparatus for controlling a mechanical power generator comprising a number of cylinders that each include a number of combustion chambers, the apparatus comprising:
computer memory storing instructions; and
a processor operable according to the instructions to:
determine whether an adjustment to the power being generated by the power generator is required; and
determine whether one or more additional combustion chambers of the power generator need to be activated based on whether an adjustment to the power being generated is required.

22. The apparatus of claim 21, wherein the processor is further operable to determine whether one or more active combustion chambers of the power generator need to be deactivated based on whether an adjustment to the power being generated is required.

23. The apparatus of claim 21, wherein the processor is further operable to determine whether to adjust the power generated by active combustion chambers based on whether an adjustment to the power being generated is required.

24. A mechanical power generator, the generator comprising:
a plurality of cylinders, each cylinder comprising:
at least three combustion chambers,
a piston in each combustion chamber, and
a plurality of connecting members coupling the pistons to each other;
a fuel controller for each combustion chamber, wherein the fuel controllers comprise a direct fuel injector;
a combustion initiation device for each combustion chamber;
an exhaust controller for each combustion chamber;
a lubrication inlet for each combustion chamber;
a lubrication outlet for each combustion chamber;
a plurality of connecting rods, each rod associated being coupled to a piston in an associated cylinder at one end and driven by the pistons of the associated cylinder;
a crankshaft coupled to another end of the connecting rods and driven thereby; and
a controller adapted to determine whether an adjustment to the power being generated by the power generator is required and to determine whether one or more additional combustion chambers of the power generator need to be activated based on whether an adjustment to the power being generated is required.
